(19) United States
(12) Patent Application Publication
(10) Pub. No.: US 2005/0268077 A1
(43) Pub. Date: Dec. 1, 2005

(54) Memory system for an electronic device and the method for controlling the same

(76) Inventors: Peter Kuan, Taipei (TW); Ta-Shin Hu, Sanchung City (TW)

Correspondence Address: Dennison, Schultz & Dougherty & MacDonald, Suite 105, 1727 King Street, Alexandria, VA, 22314, US

(21) Appl. No.: 10/842,447

(22) Filed: May 11, 2004

(51) Int. Cl. G06F 9/00

(52) U.S. Cl. 713/1

(57) ABSTRACT

A memory system applied to an electronic device has a small-capacity linear-addressed nonvolatile memory having a boot code and system information stored therein and a high-capacity data flash memory in which an operating system (OS) and frequently accessed user data are recorded. While the memory system is booting up, the boot code including the system information is fetched from the linear-addressed nonvolatile memory to start an initialization process. After completion of the initialization process, the OS is retrieved from the data flash memory and executed. During the OS retrieval, the memory system provides an ECC/EDC unit to detect whether any bit error occurs and to correct any if present. Since the boot code and OS are stored in different memories, the bit error rate (BER) is effectively reduced.

### BACKGROUND OF THE INVENTION

1. Field of the Invention

The present invention relates to a memory system applied for an electronic device, more particularly, the memory system utilizes a small linear addressing nonvolatile memory in company with a controller to control a high-capacity data flash memory.

2. Description of Related Art

The traditional memory system design for mobile phone or PDA systems usually employs code flash memory (e.g., NOR flash memory). Code flash memory consists of blocks designated to store the system boot code, the operating system (OS), and user data. This kind of memory design may be the simplest method, but it is also the least flexible for the system designer when it becomes necessary to expand the memory capacity. Limited by the linear addressing of the NOR flash memory, the entire memory system hardware must be changed in order to extend the data storage capacity. Further, although NOR flash memory possesses the eXecute In Place (XIP) function, its programming and erasing speed is quite poor compared with the data flash memory (e.g., NAND flash memory).

Moreover, because NOR flash memory uses linear addressing design, every memory cell must function normally, i.e., no memory cell can be permitted to have bad data. In comparison to data flash memory (i.e., NAND flash memory), which can tolerate bad blocks in memory, the fabricating cost of the NOR flash memory is understandably much higher. With the ever-increasing requirements for high-capacity memory, the cost difference between the two kinds of memories has become more apparent.

A conventional cell phone memory system consisting of a CPU (100), code flash memory (101), and volatile memory (102) is represented in FIG. 3. When the cell phone is activated, the CPU (100) first reads the binary execute boot code (103) stored in the code flash memory (101). After system initialization, the operating system (OS) image (104) is fetched from the code flash memory and executed. Note that during the OS execution process, some temporary files are created in volatile memory (102), which may be either Dynamic Random Access Memory (DRAM) or Static Random Access Memory (SRAM). Using these temporary files, when the system needs to read user data (105), the CPU (100) can also retrieve the required information from user data blocks in code flash memory (101).

With increasing memory capacity, the RC value of the memory will also become larger. Such a high RC value usually leads to a longer data accessing time and is unfavorable to the entire system efficiency. Moreover, the OS image (104) in the code flash memory (101) must be stored in the form of binary execute boot code. Since the OS image (104) usually occupies a lot of storage space, this implies that a high-capacity code flash memory is necessary for the XIP function.

Alternatively, if the OS is first compressed and then stored in the code flash memory (101), the OS will be moved to the DRAM or SRAM and decompressed after initialization is finished. However, the XIP function of the code flash memory (101) is completely abandoned.

Some differences between code flash memory and data flash memory are briefly discussed below.

Code flash memory usually utilizes a fully mapped linear addressing technique. This means the address lines and data lines are directly coupled to the system without the Error Checking and Correcting (ECC) and Error Detecting and Coding (EDC) abilities. After system startup, a bit error may possibly occur when a great quantity of data is accessed or erased. Since all kinds of data—including binary execute boot code (103), OS (104), and user data (105)—are stored in the same code flash memory (101), the bit error may cause critical damage. For example, it is possible that when intending to erase user data (105), abnormal level status on the address lines may cause the boot code (103) to be accidentally erased instead. As mentioned above, a large RC value may lead to long data reading, writing, and erasing times. The high RC value would thus increase the possibility of bit errors since the Bit Error Rate (BER) is in direct proportion to the data accessing time.

In another aspect, the possibility of abnormal data being written in a critical area of data flash memory is much lower than for code flash memory. That is because data can only be successfully written to or erased from data flash memory by writing or erasing the correct data several times in succession. However, since the data flash memory design employs the “multi-function pins” technique, it is unable to provide a binary execute boot code during the system startup. To solve this problem, a small-capacity code flash memory can be employed to store the binary execute boot code.

For some systems that use a single large-capacity data flash memory in company with built-in SRAM as the boot loader, since the boot code is stored in the first block (block 0) of the data flash memory, during system startup the boot code still needs to be moved to the SRAM with a state machine. This data transfer procedure needs a long time and thus may cause a serious delay to the subsequent initializing of the display device. Further, when an unexpected writing action occurs in a critical data area of the data flash memory, the system may not be able to be booted any more. In short, it is difficult to provide a reliable memory system using a single data flash memory and even when done so, it involves a long startup time.

Therefore, it is desired to provide a unique memory system to obviate the aforementioned drawbacks.

### SUMMARY OF THE INVENTION

The objective of the present invention is to provide a unique memory system for electronic devices, wherein the data flash memory and code flash memory are integrated together thus simultaneously possessing the advantages (such as fast system startup time, low bit error rate, and emergency recovery data) of these two different types of memories.

To accomplish the foregoing objective, the memory system of the present invention comprises:
a control unit coupled to the CPU of the electronic device;
linear-addressed nonvolatile memory coupled to the control unit, wherein a boot code is stored in the linear-addressed nonvolatile memory; and
data flash memory operated by the control unit and having an operating system (OS) and frequently accessed user data therein;

While the memory system is booting, the CPU fetches the boot code from the linear-addressed nonvolatile memory to start initial processes, and then fetches the OS and the user data from the data flash memory to finish the system booting process.

Other objects, advantages, and unique features of the invention will become more apparent from the following detailed description and accompanying drawings.

### BRIEF DESCRIPTION OF THE DRAWINGS

FIG. 1 is a block diagram showing a memory system applied in an electronic device in accordance with the present invention.

FIG. 2 is a flow chart showing the booting processes of the electronic device of FIG. 1.

FIG. 3 is a block diagram showing a conventional memory system of a cell phone.

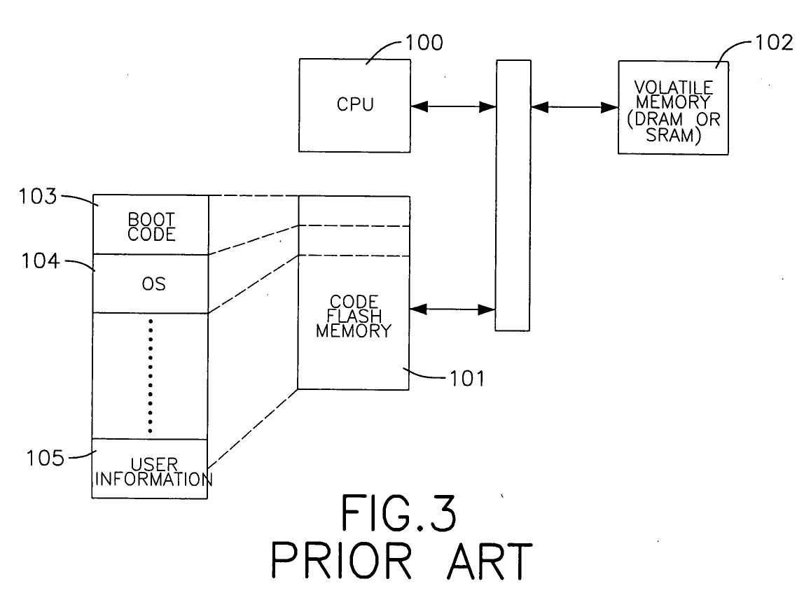

### DETAILED DESCRIPTION OF THE PREFERRED EMBODIMENT

As discussed in the prior art, data flash memory and code flash memory both possess their respective advantages and limitations; however, data flash memory is still superior to code flash memory in the aspects of extended capacity and data reading/writing reliability. Although the system is unable to directly retrieve the boot code from the data flash memory, using code flash memory of a small capacity can solve the problem. The present invention thus integrates the foregoing two types of memories as a unique memory system and is applied for use in electronic products.

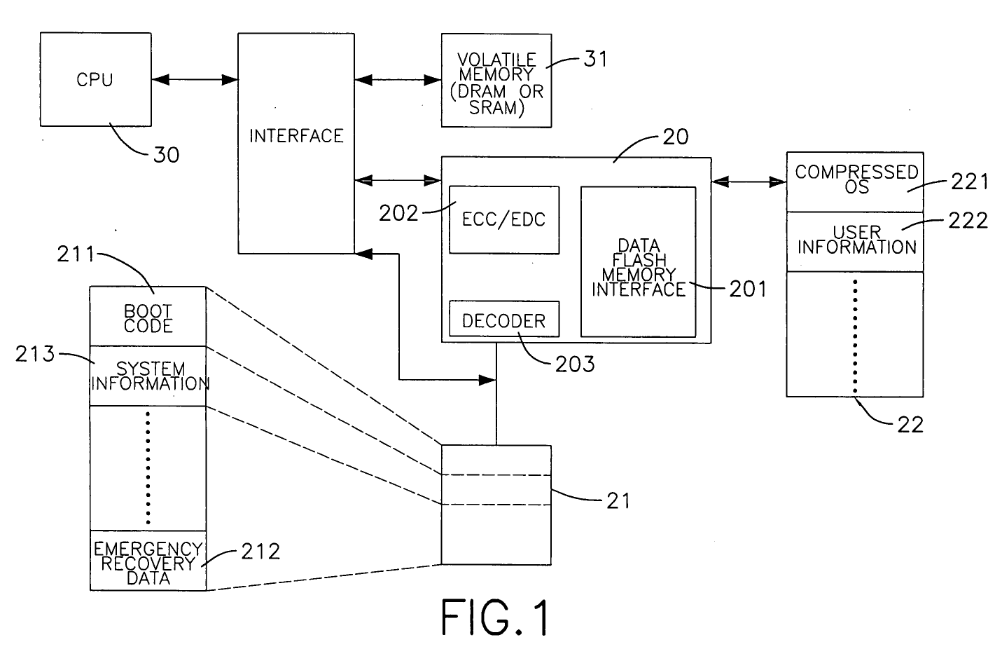

With reference to FIG. 1, the memory system according to the present invention is applied in an electronic device (for example, a cell phone or PDA), and comprises a control unit (20), linear-addressing nonvolatile memory (21), and data flash memory (22).

The control unit (20) couples to a CPU (30) of the electronic device through an interface (not numbered), wherein volatile memory (31) such as a DRAM or SRAM is further connected to the CPU (30), also through the interface.

The linear-addressed nonvolatile memory (21) coupled to the control unit (20) and the interface is a code flash memory with a small capacity (for example, 1Mbit, 2Mbit, 4Mbit, or 8Mbit).

The capacity of the data flash memory (22) is much larger than that of the linear-addressed nonvolatile memory (21), and its operation is controlled by output commands of the control unit (20).

The linear-addressed nonvolatile memory (21) with XIP capability can be programmed to store binary execute boot code (211), emergency recovery data (212), and system information (213). Because the binary execute boot code (211) only occupies a small space, the emergency recovery data (212) and system information (213) can be stored in the remaining portion of the linear-addressed nonvolatile memory (21). Moreover, both the compressed OS (221) and the frequently accessed user data (222) are located in the data flash memory (22).

The control unit (20) further comprises a data flash memory interface (201), an ECC/EDC unit (202), and a decoder (203). Through the data flash memory interface (201), the control unit (20) is coupled to the data flash memory (22). The ECC/EDC unit (202) is used to detect whether bit errors occur during the data transferring stage and to generate a warning flag based on detected bit errors. The decoder (203) identifies the address signals from the CPU (30) to differentiate operations among the linear-addressed nonvolatile memory (21), the ECC/EDC unit (202), and the data flash memory interface (201).

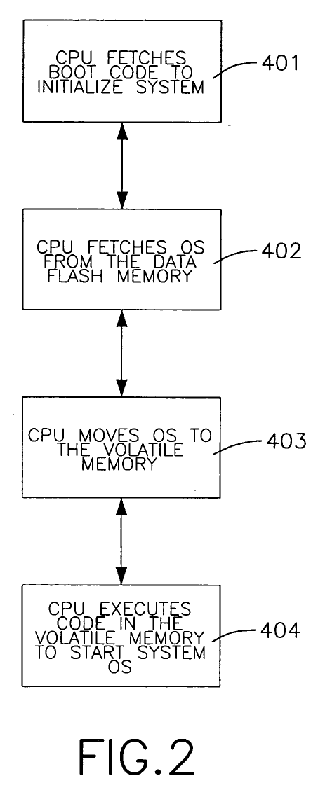

The detailed operation processes of the foregoing memory system are illustrated in FIG. 2. When the system is activated, the CPU (30) fetches the boot code (211) from the linear-addressed nonvolatile memory (21) and executes initialization procedures. After completion of the initialization procedures (401), the CPU (30) run procedures (402) to output commands to the control unit (20) thus retrieving the OS (221) from the data flash memory (22) and goto procedures (403) to move the OS (221) to the volatile memory (31) (i.e., SRAM or DRAM). The CPU (30) then executes the procedures (404) to start the OS (221) in the volatile memory (31).

Furthermore, when it needs to read/write the user data, the CPU (30) will fetch the data from the data flash memory (22) and then load the data to the linear-addressed volatile memory (31). During the transfer of data between the data flash memory (22) and the volatile memory (31), the ECC/EDC unit (202) detects whether the bit errors occur and then corrects any errors if found.

When comparing the present invention with a conventional memory system that adopts a single data flash memory or a code flash memory, the present inventions has the following advantages:

1. Because the present invention employs a small capacity linear-addressed nonvolatile memory as the first device accessed while the system is booting up, the short startup time is as fast or even faster than that of a memory system using a single code flash memory.

2. In the present memory system, the boot code is independently stored in a small-capacity linear-addressed nonvolatile memory, while the compressed OS and the user data are stored in high-capacity data flash memory. Such a separated data arrangement allows the memory system to have a lower bit error rate (BER) in comparison with conventional memory systems (in which all kinds of data are saved in the same memory).

3. Since the compressed OS and the frequently accessed user data are stored in the high-capacity data flash memory, and an ECC/EDC unit is provided to detect and correct any possible errors, the bit error rate (BER) can be effectively reduced.

4. The boot code stored in the nonvolatile memory only occupies a small amount of space so that the emergency recovery data can be completely saved in the memory. Further, even when the data flash memory has a bad block, the system still can be successfully booted by the nonvolatile memory and then be recovered to the original status.

5. The small-capacity linear-addressed nonvolatile memory is operated in “read-only” mode, and only the OS and user data in the data flash memory can be read/written. Because of this, the possibility of system initializing failure is reduced.

6. The present invention retains the good system reliability of the conventional memory system using a single code flash memory. Moreover, the entire system cost of the present invention is much lower than portable systems using code flash memory and data flash memory systems. The present invention also offers lower power consumption.

It is to be understood, however, that even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

1. A memory system applied for use in an electronic device having a CPU and a volatile memory, the memory system comprising:
a control unit (20) coupled to the CPU of the electronic device;
linear-addressed nonvolatile memory (21) coupled to the control unit (20), wherein a boot code (211) is stored in the linear-addressed nonvolatile memory (21); and
data flash memory (22) operated by the control unit (20) and having an operating system (OS) (221) and frequently accessed user data (222) therein;
wherein the CPU (30) fetches the boot code (211) and system information (213) from the linear-addressed nonvolatile memory (21) to start initialization processes when the memory system is booting, and then fetches the OS (221) and the user data from the data flash memory (22) to complete the system booting process.

2. The memory system as claimed in claim 1, the control unit (20) further comprising:
a data flash memory interface (201) through which the control unit (20) is coupled to the data flash memory (22);
an ECC/EDC unit (202), which is used to detect whether any bit error occurs while the data flash memory (22) is transferring data and then corrects any detected bit error; and
a decoder (203), which identifies address signals from the CPU (30) to differentiate operations among the linear-addressed nonvolatile memory (21), the ECC/EDC unit (202), and the data flash memory interface (201).

3. The memory system as claimed in claim 1, wherein the linear-addressed nonvolatile memory (21) is a code flash memory of small capacity.

4. The memory system as claimed in claim 2, wherein the linear-addressed nonvolatile memory (21) is a code flash memory of small capacity.

5. The memory system as claimed in claim 3, wherein the linear-addressed nonvolatile memory (21) stores an emergency recovery therein.

6. The memory system as claimed in claim 4, wherein the linear-addressed nonvolatile memory (21) stores an emergency recovery therein.

7. The memory system as claimed in claim 5, wherein the fetched operating system from the data flash memory (22) is then loaded to the volatile memory (31).

8. The memory system as claimed in claim 6, wherein the fetched operating system from the data flash memory (22) is then loaded to the volatile memory (31).

9. The memory system as claimed in claim 7, wherein the operating system stored in the data flash memory (22) has been compressed.

10. The memory system as claimed in claim 8, wherein the operating system stored in the data flash memory (22) has been compressed.

11. The memory system as claimed in claim 1, wherein the linear-addressed nonvolatile memory (21) is NOR flash memory or mask ROM and the data flash memory (22) is NAND or AND flash memory.

12. The memory system as claimed in claim 9, wherein the linear-addressed nonvolatile memory (21) is NOR flash memory or mask ROM and the data flash memory (22) is NAND or AND flash memory.

13. The memory system as claimed in claim 10, wherein the linear-addressed nonvolatile memory (21) is NOR flash memory or mask ROM and the data flash memory (22) is NAND or AND flash memory.

14. A method for controlling a memory system, the method comprising the acts of:
retrieving a boot code from linear-addressed nonvolatile memory (21) and executing the boot code so as to complete an initialization process;
retrieving an operating system (221) from data flash memory (22) and then loading the operating system (221) to volatile memory (31);
executing the operating system (221) in the volatile memory (31); and
accessing user data (222) stored in the data flash memory.

15. The method as claimed in claim 14 further comprising the acts of:
detecting whether any bit error occurs while the data flash memory is being accessed; and
correcting any detected bit error.

16. The method as claimed in claim 14 further comprising the act of:
retrieving emergency recovery data from the linear-addressed nonvolatile memory (21) if the data flash memory (22) has any bad block.

17. The method as claimed in claim 15 further comprising the act of:
retrieving emergency recovery data from the linear-addressed nonvolatile memory (21) if the data flash memory (22) has any bad block.
